(19) United States
(12) Patent Application Publication
(10) Pub. No.: US 2024/0231726 A1
(43) Pub. Date: Jul. 11, 2024

(54) METHOD OF CONTROLLING INFORMATION PROCESSING APPARATUS, AND STORAGE MEDIUM

(71) Applicant: CANON KABUSHIKI KAISHA, Tokyo (JP)

(72) Inventor: ARATA MIYAGI, Kanagawa (JP)

(21) Appl. No.: 18/398,692

(22) Filed: Dec. 28, 2023

(30) Foreign Application Priority Data
Jan. 6, 2023 (JP) 2023-001228

(51) Int. Cl. G06F 3/12

(52) U.S. Cl. CPC G06F 3/126; G06F 3/1203; G06F 3/1228; G06F 3/1232; G06F 3/1287

(57) ABSTRACT

A method of controlling an information processing apparatus having a general-purpose driver that operates according to IPP. Information on whether or not a job management apparatus has a queueing function of queueing a plurality of jobs is acquired, and a method of transmitting jobs generated by the general-purpose driver is changed based on the acquired information.

### BACKGROUND OF THE INVENTION

### Field of the Invention

The present invention relates to a method of controlling an information processing apparatus, and a storage medium.

### Description of the Related Art

Conventionally, there is known a printer that receives a print job (print data) from a terminal apparatus, such as a personal computer, and forms an image by performing printing on paper, such as a sheet, based on the received print job. Further, in the terminal apparatus, a printer driver (or a print application) designed to use an individual printer is installed. The print job is generated by this printer driver. In recent years, there is known a method of generating a print job by using a general-purpose printer driver based on a standard specification without using the printer driver designed for the purpose of using an individual printer. The “general-purpose printer driver” is a standard printer driver which is installed in an operating system (OS) in advance, i.e. a printer driver that operates based on an industry-standard protocol, such as the Internet Printing Protocol (IPP).

Japanese Laid-Open Patent Publication (Kokai) No. 2011-165009 discloses an image forming apparatus (print job management apparatus) that queues a plurality of print jobs and sequentially processes, i.e. prints the plurality of queued print jobs from the top print job. Further, the image forming apparatus described in Japanese Laid-Open Patent Publication (Kokai) No. 2011-165009 receives a print job from a terminal apparatus (print client) that can communicate with the image forming apparatus. The print job has been generated by a printer driver installed in the terminal apparatus. Further, this printer driver is considered to be not a general-purpose printer driver, but a printer driver adapted to each image forming apparatus.

However, in Japanese Laid-Open Patent Publication (Kokai) No. 2011-165009, for example, in a case where a general-purpose printer driver has been installed in the terminal apparatus, it is impossible to determine, by using this general-purpose printer driver, whether or not an image forming apparatus which can communicate with the terminal apparatus can queue a plurality of print jobs. In this case, for example, there can be caused a problem that even if the image forming apparatus can queue a plurality of print jobs, a plurality of print jobs are not transmitted from the terminal apparatus, or inversely, even if the image forming apparatus cannot queue a plurality of print jobs, a plurality of print jobs are transmitted from the terminal apparatus. Further, in Japanese Laid-Open Patent Publication (Kokai) No. 2011-165009, in a case where a user desires to change the order of execution of a plurality of print jobs, even if the image forming apparatus can queue a plurality of print jobs, the image forming apparatus cannot change the order of execution.

### SUMMARY OF THE INVENTION

The present invention provides a mechanism capable of changing a method of transmitting jobs to a job management apparatus, depending on whether or not the job management apparatus has a queueing function.

The present invention provides a method of controlling an information processing apparatus having a general-purpose driver that operates according to IPP, including acquiring information on whether or not a job management apparatus has a queueing function of queueing a plurality of jobs, and changing a method of transmitting jobs generated by the general-purpose driver, based on the acquired information.

According to the present invention, it is possible to change the method of transmitting jobs to the job management apparatus, depending on whether or not the job management apparatus has the queueing function.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a terminal apparatus according to a first embodiment of the present invention.

FIG. 2 is a block diagram showing a hardware configuration of a printer according to the first embodiment.

FIG. 3 is a sequence diagram showing a sequence of processing operations performed between a user, the terminal apparatus, and the printer.

FIGS. 4A and 4B are diagrams each showing an example of a screen displayed on a display section of the terminal apparatus.

FIG. 5 is a flowchart of a process performed by the terminal apparatus.

FIG. 6 is a diagram showing an example of contents of communication between the terminal apparatus and the printer.

FIG. 7 is a diagram showing an example of contents of communication between the terminal apparatus and the printer.

FIG. 8 is a flowchart of a process performed by the printer.

FIGS. 9A to 9C are diagrams each showing an example of a screen displayed on a display section of the printer.

FIG. 10 is a flowchart of a process performed by a terminal apparatus according to a second embodiment of the present invention.

FIGS. 11A to 11C are diagrams each showing an example of a screen displayed on a display section of a terminal apparatus according to a third embodiment of the present invention.

### DESCRIPTION OF THE EMBODIMENTS

The present invention will now be described in detail below with reference to the accompanying drawings showing embodiments thereof. However, the following description of the configuration of the embodiments is given by way of example, and the scope of the present invention is not limited to the described configurations of the embodiments. For example, each component of the present invention can be replaced by a desired component which can exhibit the same function. Further, a desired component can be added. Further, two or more desired components (features) of the embodiments can be combined.

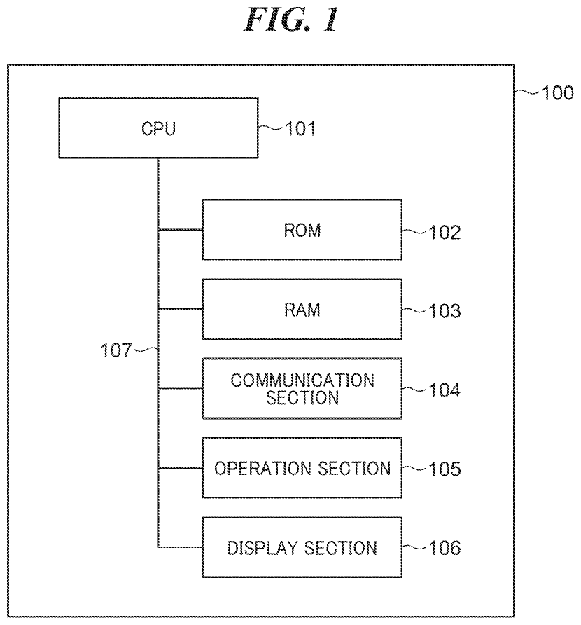

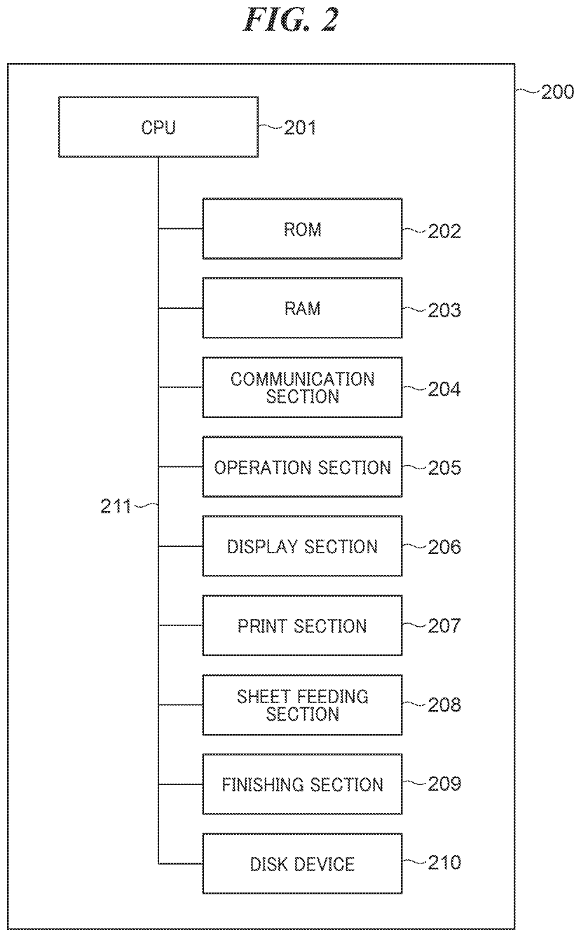

Hereafter, a first embodiment will be described with reference to FIGS. 1 to 9C. FIG. 1 is a block diagram showing a hardware configuration of a terminal apparatus according to the first embodiment of the present invention. The terminal apparatus shown in FIG. 1, denoted by reference numeral 100, is a print client (print client apparatus) that is communicably connected to a printer 200 (see FIG. 2) and used in the connected state. This terminal apparatus 100 is an information processing apparatus that is capable of processing information by communication with the printer 200. The terminal apparatus 100 is not particularly limited, but for example, a desktop-type or laptop-type personal computer, a tablet terminal, a smartphone, or the like is used as the terminal apparatus 100. Further, the information transmitted and received between the terminal apparatus 100 and the printer 200 includes, as described hereinafter, function information on whether or not the printer 200 has a queueing function of queueing a plurality of print jobs (hereinafter sometimes simply referred to as the “function information”). Note that the function information is not limited. The terminal apparatus 100 includes a central processing unit (CPU) 101, a read only memory (ROM) 102, a random access memory (RAM) 103, a communication section 104, an operation section 105, and a display section 106, and these components are connected via a bus 107 in a state communicable with each other.

The CPU 101 is a computer that executes programs stored in the RAM 103. These programs include, for example, a control program (control program of the information processing apparatus) for causing the CPU 101 to cause the components of the terminal apparatus 100 to operate. Further, the CPU 101 can read and write data stored in the RAM 103 according to an instruction of the program. The ROM 102 is a nonvolatile memory. The CPU 101 can load data stored in the ROM 102 into the RAM 103. The RAM 103 is a volatile memory. The RAM 103 stores programs executed by the CPU 101, a variety of data, and so forth. The communication section 104 is a communication module conforming to a wired standard (Ethernet (registered trademark)) or a wireless standard (Wi-Fi (registered trademark)). The communication section 104 can communicate with a communication section 204 of the printer 200 via an external network. The operation section 105 is comprised of, for example, a keyboard, a mouse, and a touch panel. With this, the operation section 105 can receive an input from a user 300 operating the terminal apparatus 100. Further, the CPU 101 can detect input information received by the operation section 105. The display section 106 is implemented by a display device. On the display section 106, for example, information on a variety of applications and the like are displayed.

FIG. 2 is a block diagram showing a hardware configuration of the printer according to the first embodiment. The printer (image forming apparatus) 200 shown in FIG. 2 is a job management apparatus that manages jobs and is implemented by a multi-function peripheral (MFP) having a variety of functions, including a print function, a copy function, and a scanner function. Note that the printer 200 is not limited to the MFP, but, for example, the printer 200 can be a single function peripheral (SFP) having only a print function. The printer 200 includes a CPU 201, a ROM 202, a RAM 203, the communication section 204, an operation section 205, a display section 206, a print section 207, a sheet feeding section 208, a finishing section 209, and a disk device 210, and these components are connected via a bus 211 in a state communicable with each other.

The CPU 201 is a computer that executes programs stored in the ROM 202. These programs include, for example, a control program (control program of the job management apparatus) for causing the CPU 201 to cause the components of the printer 200 to operate. Further, the CPU 201 can read and write data stored in the RAM 203 according to an instruction of the program. The ROM 202 is a nonvolatile memory. The CPU 201 can load data stored in the ROM 202 into the RAM 203. The RAM 203 is a volatile memory. In the RAM 203, programs, a variety of data, and so forth are loaded, for execution by the CPU 201. The communication section 204 is a communication module of a wired (Ethernet) or wireless (Wi-Fi) standard. As described above, the communication section 204 can communicate with the communication section 104 of the terminal apparatus 100 via the external network. The operation section 205 is comprised of, for example, a touch panel and buttons. With this, the operation section 205 can receive an input from the user 300. Further, the CPU 201 can detect input information received by the operation section 205. The display section 206 is implemented by a display device. On the display section 206, for example, a state of the printer 200 is displayed.

The print section 207 includes, for example, a printer head (not shown) of the inkjet type which ejects ink, an ink supply section (not shown) that supplies ink, and so forth. With this, the print section 207 can form an image on a sheet fed from the sheet feeding section 208. Note that the print section 207 is not limited to the inkjet type, but for example, the electrophotographic type using laser irradiation can be used. The sheet feeding section 208 is controlled by the CPU 201 to feed a variety of sheets, including cut paper sheets, such as a A-size sheet and a B-size sheet, a roll paper sheet, to the print section 207. The finishing section 209 is controlled by the CPU 201 to perform finishing on sheets printed by the print section 207. The finishing section 209 has, for example, a stapler that binds each set of sheets with staples, a cutter that cuts the roll paper at a designated position, and a laminator that performs lamination processing on a sheet. Further, the finishing section 209 can also apply special transparent ink so as to add gloss to a sheet or improve the weather resistance. The disk device 210 is a large-capacity storage device, such as a hard disk drive or a solid-state drive (SSD). In the disk device 210, data items of a variety of jobs, such as data items of print jobs (print documents) transmitted from the terminal apparatus 100, are stored.

As described above, the terminal apparatus 100 and the printer 200 are connected in the state communicable with each other. With this, the terminal apparatus 100 can transmit a job from the communication section 104 to the printer 200. Thus, in the terminal apparatus 100, the communication section 104 functions as transmitting means for transmitting a job to the printer 200. On the other hand, the printer 200 can receive a job from the terminal apparatus 100 via the communication section 204. Thus, in the printer 200, the communication section 204 functions as receiving means for receiving a job. Note that a job transmitted and received between the terminal apparatus 100 and the printer 200 is a print job in the present embodiment but is not limited to this. Further, in the present embodiment, a general-purpose printer driver has been installed in the terminal apparatus 100. The print job is generated by the general-purpose printer driver. The “general-purpose printer driver” is a standard printer driver which has been installed in the OS of the terminal apparatus 100, i.e. a printer driver that operates based on a standard protocol, such as the Internet Printing Protocol (IPP).

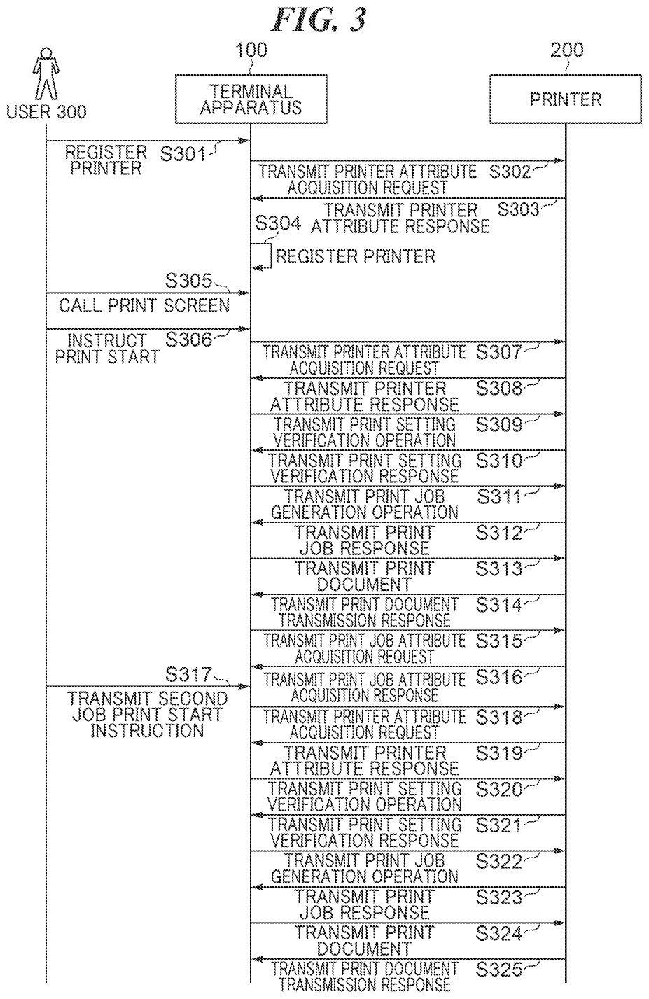

FIG. 3 is a sequence diagram showing a sequence of processing operations performed between a user, the terminal apparatus, and the printer. As shown in FIG. 3, in a step S301, the user 300 operates the operation section 105 of the terminal apparatus 100 to provide a printer registration instruction for registering the printer 200 in the terminal apparatus 100.

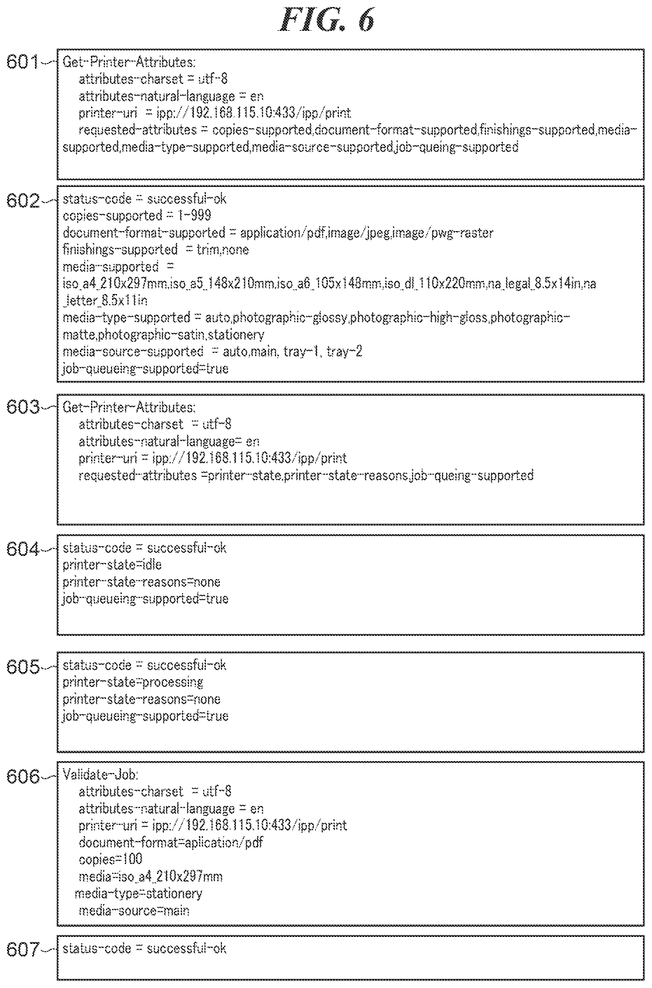

In a step S302, after receiving the printer registration instruction provided in the step S301, the CPU 101 generates a printer attribute acquisition request 601 (see FIG. 6) for requesting the attributes of the printer 200 and transmits the generated printer attribute acquisition request 601 from the communication section 104 to the printer 200. The “printer attribute” refers to information for identifying the printer 200, and the like.

In a step S303, after receiving the printer attribute acquisition request 601 transmitted in the step S302 via the communication section 204, the CPU 201 of the printer 200 generates a printer attribute acquisition response 602 (see FIG. 6) in response to the printer attribute acquisition request 601 and transmits the generated printer attribute acquisition response 602 from the communication section 204 to the terminal apparatus 100.

In a step S304, the CPU 101 receives the printer attribute acquisition response 602 via the communication section 104, and stores the printer attributes included in the printer attribute acquisition response 602 in the RAM 103. With this, registration of the printer in the terminal apparatus 100 is completed.

In a step S305, the user 300 operates the operation section 105 of the terminal apparatus 100 to display (call) a print setting screen on the display section 106.

In a step S306, the user 300 provides a print start instruction for instructing the printer 200 to start printing from the print setting screen displayed in the step S305.

In a step S307, after receiving the print start instruction provided in the step S306, the CPU 101 generates a printer attribute acquisition request 603 (see FIG. 6) for requesting the attributes of the printer 200 and transmits the generated printer attribute acquisition request 603 from the communication section 104 to the printer 200.

In a step S308, after receiving the printer attribute acquisition request 603 transmitted in the step S307 via the communication section 204, the CPU 201 generates a printer attribute acquisition response 604 (see FIG. 6) in response to the printer attribute acquisition request 603 and transmits the generated printer attribute acquisition response 604 from the communication section 204 to the terminal apparatus 100.

In a step S309, after receiving the printer attribute acquisition response 604 transmitted in the step S308 via the communication section 104, the CPU 101 inspects the state of the printer 200 based on information included in the printer attribute acquisition response 604. As a result of this inspection, if the printer 200 is in a printable state, the CPU 101 transmits a print setting verification operation 606 (see FIG. 6) based on the print start instruction provided in the step S306 from the communication section 104 to the printer 200.

In a step S310, after receiving the print setting verification operation 606 transmitted in the step S309 via the communication section 204, the CPU 201 determines whether or not printing can be performed under printing conditions included in the print setting verification operation 606, and if it is determined that printing can be performed, the CPU 201 generates a print setting verification response 607 (see FIG. 6) including “status-code=successful-ok” indicating that printing can be performed (success) and transmits the generated print setting verification response 607 from the communication section 204 to the terminal apparatus 100.

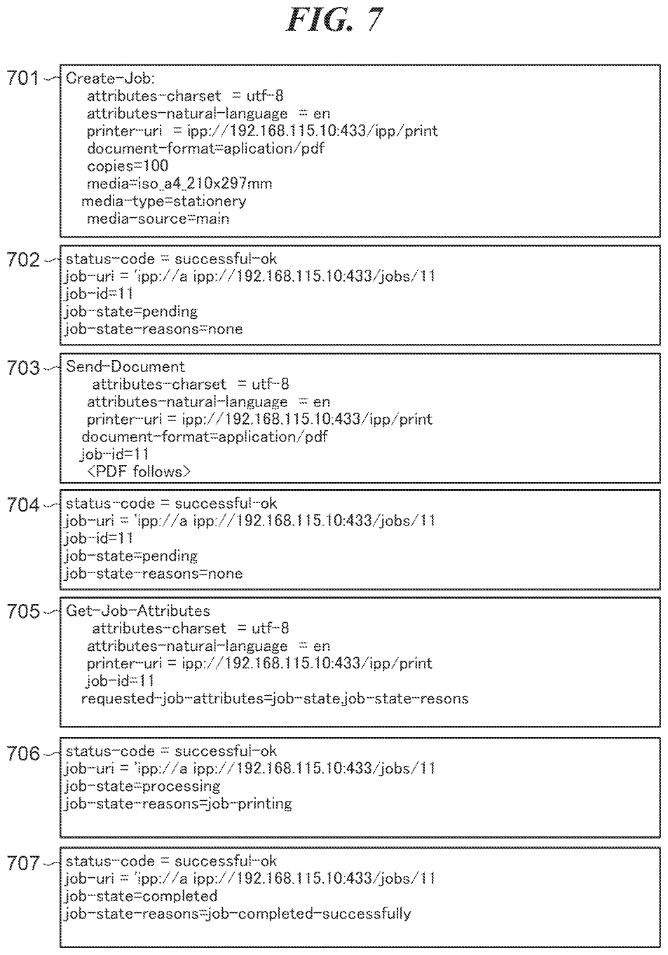

In a step 311, after receiving the print setting verification response 607 transmitted in the step S310 via the communication section 104, the CPU 101 generates a job generation operation 701 (see FIG. 7) including a print job and transmits the generated job generation operation 701 from the communication section 104 to the printer 200.

In a step S312, after receiving the job generation operation 701 transmitted in the step S311 via the communication section 204, the CPU 201 generates a print job response 702 (see FIG. 7) in response to the job generation operation 701 and transmits the generated print job response 702 from the communication section 204 to the terminal apparatus 100.

In a step S313, after receiving the print job response 702 transmitted in the step S312 via the communication section 104, the CPU 101 generates a print document transmission operation 703 (see FIG. 7) including print document information and transmits the generated print document transmission operation 703 from the communication section 104 to the printer 200.

In a step S314, after receiving the print document transmission operation 703 transmitted in the step S313 via the communication section 204, the CPU 201 generates a print document transmission response 704 (see FIG. 7) in response to the print document transmission operation 703 and transmits the generated print document transmission response 704 from the communication section 204 to the terminal apparatus 100. The print document transmission response 704 indicates, for example, that the state of the job (job-state) in the printer 200 is an execution waiting state (pending). Further, the CPU 201 records the print document information included in the print document transmission operation 703 in the disk device 210 and shifts the printer 200 to a processing state to process the print document information.

In a step S315, after receiving the print document transmission response 704 transmitted in the step S314 via the communication section 104, the CPU 101 generates a print job attribute acquisition request 705 (see FIG. 7) for acquiring the attributes of the print job and transmits the generated print job attribute acquisition request 705 from the communication section 104 to the printer 200.

In a step S316, after receiving the print job attribute acquisition request 705 transmitted in the step S315 via the communication section 204, the CPU 201 generates a print job attribute acquisition response 706 (see FIG. 7) in response to the print job attribute acquisition request 705 and transmits the generated print job attribute acquisition response 706 from the communication section 204 to the terminal apparatus 100. By receiving this response, the CPU 101 of the terminal apparatus 100 can display the information on the print job on the display section 106 based on the job attributes included in the print job attribute acquisition response 706.

In a step S317, similarly to the step S306, the user 300 provides a print start instruction for instructing the printer 200 to start the second printing (print job) from the print setting screen.

In a step S318, the CPU 101 receives the second print start instruction provided in the step S317. Then, similarly to the step S307, the CPU 101 transmits the printer attribute acquisition request 603 from the communication section 104 to the printer 200.

In a step S319, after receiving the printer attribute acquisition request 603 transmitted in the step S318 via the communication section 204, the CPU 201 inspects the job state of a JOB-ID associated with the printer attribute acquisition request 603 and generates a proper response. For example, if a result of the inspection indicates that the printer 200 is processing the job, the CPU 201 sets an attribute value indicating that the printer 200 is processing the job and generates a printer attribute acquisition response 605 (see FIG. 6) including the attribute value to transmit the printer attribute acquisition response 605 as the proper response from the communication section 204 to the terminal apparatus 100. On the other hand, if a result of the inspection indicates that the print job has already been completed, the CPU 201 sets an attribute value indicating completion of the job and generates a print job completion response 707 (see FIG. 7) including the attribute to transmit the print job completion response 707 as the proper response.

In a step S320, after receiving the printer attribute acquisition response 605 transmitted in the step S319 via the communication section 104, the CPU 101 inspects the state of the printer 200 based on the information included in the printer attribute acquisition response 605. If a result of this inspection indicates that the printer 200 is in a printable state, the CPU 101 transmits the print setting verification operation 606 based on the second print start instruction provided in the step S317 from the communication section 104 to the printer 200.

In a step S321, after receiving the print setting verification operation 606 transmitted in the step S320 via the communication section 204, similarly to the step S310, the CPU 201 transmits the print setting verification response 607 from the communication section 204 to the terminal apparatus 100.

In a step 322, after receiving the print setting verification response 607 transmitted in the step S321 via the communication section 104, similarly to the step S311, the CPU 101 transmits the job generation operation 701 from the communication section 104 to the printer 200.

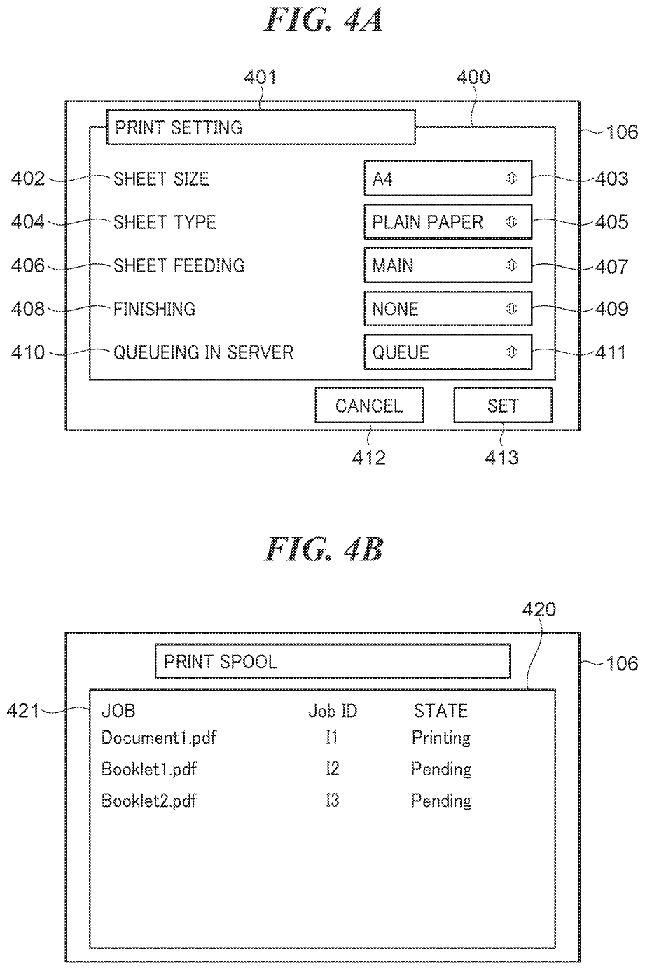

In a step S323, after receiving the job generation operation 701 transmitted in the step S322 via the communication section 204, similarly to the step S312, the CPU 201 transmits the print job response 702 from the communication section 204 to the terminal apparatus 100. Note that in the print job response 702 transmitted at this time, the job-id is incremented by one to be set to “I2” (see, for example, FIG. 4B).

In a step S324, after receiving the print job response 702 transmitted in the step S323 via the communication section 104, similarly to the step S313, the CPU 101 transmits the print document transmission operation 703 from the communication section 104 to the printer 200. Note that the job-id at this time is the same as “I2” set in the step S323.

In a step S325, the CPU 201 receives the print document transmission operation 703 transmitted in the step S324 via the communication section 204. Then, similarly to the step S314, the CPU 201 transmits the print document transmission response 704 from the communication section 204 to the terminal apparatus 100. Note that the job-id set at this time is the same as “I2” set in the step S323.

FIGS. 4A and 4B are diagrams each showing an example of a screen displayed on the display section of the terminal apparatus. FIG. 4A shows an example of the print setting screen displayed by execution of the step S305 in the sequence diagram shown in FIG. 3. FIG. 4B shows an example of the print job management screen displayed after execution of the step S325 in the sequence diagram shown in FIG. 3. The print setting screen shown in FIG. 4A, denoted by reference numeral 400, includes a setting display-switching menu 401, a sheet size selection section 402, a sheet type-setting section 404, a sheet feeding-setting section 406, a finishing setting section 408, a queueing selection section 410, a cancel button 412, and a set button 413. Using the setting display-switching menu 401, the setting display on the print setting screen 400 can be switched. From the setting display-switching menu 401, the setting display can be switched from print settings appearing in FIG. 4A, to, for example, detailed settings, maintenance, and so forth.

In the sheet size selection section 402, the user can change the sheet size to a desired sheet size within a range of sizes of sheets usable by the printer 200, by selecting a dropdown 403. Note that sheet sizes to which the sheet size is changeable by the dropdown 403 are determined according to a “media-supported” attribute included in the printer attribute acquisition response 602. In the sheet type-setting section 404, the user can change the sheet type to a desired sheet type within a range of types of sheets usable by the printer 200, by selecting a dropdown 405. Note that sheet types to which the sheet type is changeable by the dropdown 405 are determined according to “media-type-supported” attribute included in the printer attribute acquisition response 602. In the sheet feeding-setting section 406, the user can change the sheet feeding section 208 (sheet feeding source), i.e. a source from which a sheet is fed, by selecting a dropdown 407. Note that sheet feeding sources to which the sheet feeding source is changeable by the dropdown 407 are determined according to “media-source-supported” attribute included in the printer attribute acquisition response 602. In the finishing setting section 408, the user can change finishing to be performed by the finishing section 209 by selecting a dropdown 409. Note that the types of finishing to which the finishing is changeable by the dropdown 409 are set according to options associated with “finishings-supported” attribute included in the printer attribute acquisition response 602.

In the queueing selection section 410, the user can change execution/non-execution of queueing in the printer 200 which is also a print server (server), by selecting a dropdown 411. In a case where a “job-queueing-supported” attribute included in the printer attribute acquisition response 602 (function information) is “true”, the CPU 101 displays the queueing selection section 410 and the dropdown 411 on the print setting screen 400 in a visible state. Further, in a case where the “job-queueing-supported” attribute is “false”, the CPU 101 inhibits the display of the queueing selection section 410 and the dropdown 411 on the print setting screen 400. Further, in a case where the “job-queueing-supported” attribute is not included in the printer attribute acquisition response 602, the CPU 101 also inhibits the display of the queueing selection section 410 and the dropdown 411 on the print setting screen 400. The method of inhibiting the display is not particularly limited, but for example, there can be used a display method which disables visualization, a display method which grays out the display, or the like. Thus, in the present embodiment, the display section 106 functions as notifying means for notifying a user of whether or not the printer 200 has the queueing function. With this, the user 300 can know whether or not the printer 200 has the queueing function. Whether or not the printer 200 has the queueing function can be notified not only by using the image, but can be notified, for example, by using sound from a speaker, light emission from a signal lamp, or the like.

By operating the cancel button 412, the user can cancel issuing a print job. Further, an operation of the set button 413 by the user enables the CPU 101 to determine in the step S306 or the step S317 that the print start instruction is received.

The print job management screen shown in FIG. 4B, denoted by reference numeral 420, includes a job management area 421. In the job management area 421, a name of a print job, a job ID, and a job state are displayed. In the illustrated example in FIG. 4B, there are print jobs named as “Document1.pdf”, “Booklet1.pdf”, and “Booklet2.pdf”, respectively, and these print jobs are sequentially arranged from the top of the job management area 421. Further, the job IDs of “Document1.pdf”, “Booklet1.pdf”, and “Booklet2.pdf” are “I1”, “I2”, and “I3”, respectively. The order of display of the print jobs is based, for example, on the print job response 702, and corresponds to an order of execution of the print jobs by the printer 200. The job state is displayed, for example, based on the print job response 702, and in the case of the illustrated example, the job state of “Document1.pdf” indicates “executing (printing)”, and the job states of “Booklet1.pdf” and “Booklet2.pdf” indicate “waiting (print waiting state)”.

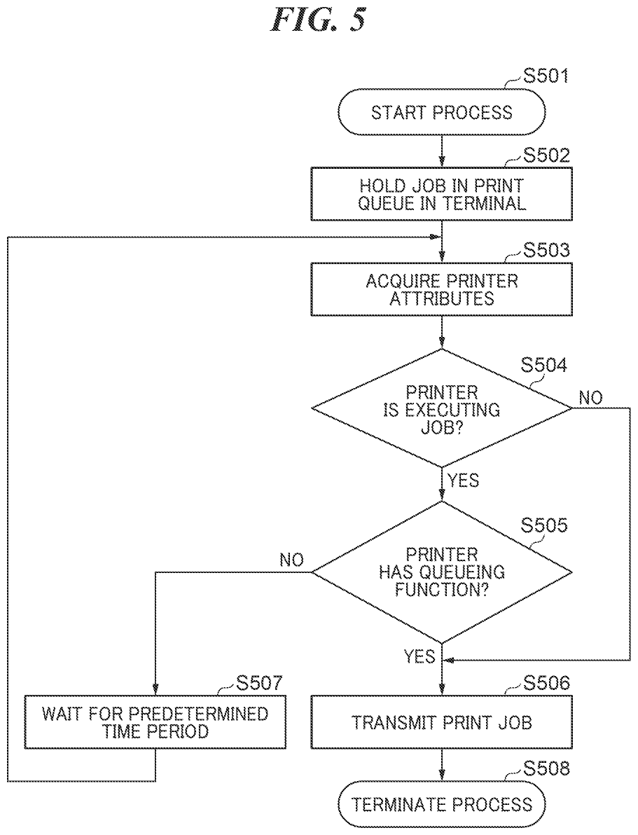

FIG. 5 is a flowchart of a process performed by the terminal apparatus. The flowchart in FIG. 5 corresponds to a process performed by the terminal apparatus 100 in the sequence diagram shown in FIG. 3. As shown in FIG. 5, in a step S501, the CPU 101 of the terminal apparatus 100 starts the process in FIG. 5 by executing an associated program, and the process proceeds to a step S502. Note that the process is started in a case where the set button 413 on the print setting screen 400 displayed on the operation section 105 is selected.

In the step S502, the CPU 101 holds a print job in the print queue provided in the RAM 103, and the process proceeds to a step S503.

In the step S503, the CPU 101 acquires the printer attribute acquisition response 602 (printer attributes), the printer attribute acquisition response 604, and the printer attribute acquisition response 605 from the printer 200 via the communication section 104, and the process proceeds to a step S504. The printer attribute acquisition response 602 includes function information on whether or not the printer 200 has the queueing function of queueing a plurality of print jobs, and so forth. The printer attribute acquisition response 604 and the printer attribute acquisition response 605 each include the information on whether or not the printer 200 is executing a print job. Further, in the terminal apparatus 100, the communication section 104 functions as information acquiring means for acquiring a variety of information including the function information.

In the step S504, the CPU 101 determines whether or not the printer 200 is executing a print job based on a result of acquisition in the step S503, i.e. the printer attribute acquisition response 604 and the printer attribute acquisition response 605. Thus, in the terminal apparatus 100, the CPU 101 also functions as determination means capable of determining whether or not the printer 200 is executing a print job. Then, if it is determined in the step S504 that the printer 200 is executing a print job, the process proceeds to a step S505. On the other hand, if it is determined in the step S504 that the printer 200 is not executing a print job, the process proceeds to a step S506.

In the step S505, the CPU 101 determines whether or not the printer 200 has the queueing function (the printer 200 supports queueing) based on the result of acquisition in the step S503, i.e. the printer attribute acquisition response 602 (function information). Thus, in the terminal apparatus 100, the CPU 101 also functions as determination means capable of determining whether or not the printer 200 has the queueing function. If it is determined in the step S505 that the printer 200 has the queueing function, the process proceeds to the step S506. On the other hand, if it is determined in the step S505 that the printer 200 does not have the queueing function, the process proceeds to a step S507. Note that in the step S505, if the “job-queueing-supported” attribute included in the printer attribute acquisition response 602 is “true”, it is determined that the printer 200 has the queueing function. On the other hand, if the “job-queueing-supported” attribute included in the printer attribute acquisition response 602 is “false”, or if the “job-queueing-supported” attribute is not included, it is determined that the printer 200 does not have the queueing function.

In the step S506, the CPU 101 transmits the print job held in the print queue in the RAM 103 from the communication section 104 to the printer 200, and the process proceeds to a step S508. Further, in this step S506, in a case where a plurality of print jobs are held in the print queue in the RAM 103, all of these print jobs can be sequentially transmitted. With this, the printer 200 having the queueing function can receive and hold all of the print jobs transmitted in the step S506.

Further, for the printer 200 which does not have the queueing function, whenever a print job held in the print queue in the RAM 103 is to be transmitted in the step S506, the CPU 101 determines whether or not the printer 200 is executing a print job. Then, if a result of this determination indicates that the printer 200 is not executing a print job, the CPU 101 transmits one of the remaining print jobs. The control operations described above are repeatedly executed for the printer 200 which does not have the queueing function until transmission of all of the print jobs held in the print queue in the RAM 103 is completed.

In the step S507, the CPU 101 waits for the lapse of a predetermined time period. For example, when the CPU 101 waits for approximately one to ten seconds, it is possible to prevent or suppress load and the like applied to the printer 200 and the network. Then, after the lapse of the predetermined time period, the process returns to the step S503 to sequentially execute the step S503 et seq.

In the step S508, the CPU 101 terminates the present process.

As described above, in the terminal apparatus 100, when a print job is transmitted in the step S506 or the step S507, the number of print jobs to be transmitted is adjusted based on the function information. Thus, in the terminal apparatus 100, the CPU 101 functions as control means for controlling the number of print jobs to be transmitted. With this control, the transmission processing for the print jobs is changed according to whether or not the printer has the queueing function. Specifically, to the printer 200 having the queueing function, it is possible to sequentially transmit all of print jobs held in the print queue in the RAM 103. Further, the printer 200 having the queueing function can hold all of the print jobs received from the terminal apparatus 100 and then sequentially execute each print job. On the other hand, to the printer 200 that does not have the queueing function, it is possible to transmit one print job held in the print queue in the RAM 103. The printer 200 that does not have the queueing function can hold the one print job received from the terminal apparatus 100 and then execute the print job. Further, the determination in the step S504 is performed in a case where the set button 413 is operated in the step S501, i.e. in a case where execution of a print job to be transmitted is instructed. This makes it possible to perform the determination in the step S504 at a proper timing before transmitting the print job without waste.

FIGS. 6 and 7 are diagrams each showing an example of contents of communication between the terminal apparatus 100 and the printer 200. Note that the contents shown in FIGS. 6 and 7 are part of the actual contents, which is extracted for the explanation here, and the actual contents are not limited to these. The printer attribute acquisition request 601 in FIG. 6 is a request for acquiring a response of the printer attributes. Examples of the printer attributes include “copies-supported” indicating an attribute associated with copying, and “document-format-supported” indicating an attribute associated with the document format. Further, the printer attributes include “finishings-supported” indicating an attribute associated with finishing, “media-supported” indicating an attribute associated with the sheet, and “media-type-supported” indicating an attribute associated with the sheet type. Further, the printer attributes include “media-source-supported” indicating an attribute associated with the sheet supplying source, “job-queueing-supported” indicating an attribute associated with the queueing function, and so forth.

The printer attribute acquisition response 602 includes the capability information of the printer 200. The attributes listed therein have the following values given by way of example. The “status-code” attribute has a value of “successful-ok”, which indicates that the request from the terminal apparatus 100 is normally i.e. successfully processed. The “copies-supported” attribute has a value “1-999”, which indicates that printing up to 999 copies at maximum can be designated. The “document-format-supported” attribute has a value indicating that documents of the PDF, JPEG, and pwg-raster formats can be processed. The “finishings-supported” attribute has a value indicating that trimming (cutting of a sheet as finishing) and none (no finishing) can be performed. The “media-supported” attribute has a value indicating the sizes of sheets which can be fed to the printer 200. The “media-type-supported” attribute has a value indicating the types of sheets usable by the printer 200. The “media-source-supported” attribute has a value indicating the types of sheet feeding sources provided in the printer 200. The value, given by way of example, of the “media-source-supported” attribute indicates that as the sheet feeding sources, auto (automatic), main (main sheet feeding source), tray-1 (first tray), and tray-2 (second tray) can be used. The “job-queueing-supported” attribute has a value of “true”. This indicates that the printer 200 can receive a plurality of print jobs and queue these print jobs. In this case, the printer 200 can execute, i.e. print these print jobs sequentially in the order of reception or in an order changed as required. Note that in a case where a large-capacity storage device, such as the disk device 210, is omitted from the printer 200, the printer 200 can receive only one print job per one printing operation from the terminal apparatus 100. In this case, the value of the “job-queueing-supported” attribute is set to “false”.

The printer attribute acquisition request 603 is a request for acquiring attributes as a response. The attributes “requested-attributes” illustrated here by way of example are “printer-state” indicating the current state of the printer 200, “printer-state-reasons” indicating the completion state of the printer 200, and “job-queueing-supported” indicating an attribute associated with the queueing function.

The printer attribute acquisition response 604 is a response to the printer attribute acquisition request 603. A value “successful-ok” of the “status-code” attribute indicates that the request from the terminal apparatus 100 is normally i.e. successfully processed. A value “idle” of the “printer-state” attribute indicates that there is no job to be currently processed by the printer 200, and the printer 200 is in a state in which execution of a job is stopped. A value “none” of the “printer-state-reasons” attribute indicates that no error has occurred in the printer 200. A value “true” of the “job-queueing-supported” attribute indicates that the printer 200 can receive a plurality of print jobs and queue these print jobs, similarly to the printer attribute acquisition response 602.

The printer attribute acquisition response 605 is a response to the printer attribute acquisition request 603, similarly to the printer attribute acquisition response 604. A value “processing” of the “printer-state” attribute indicates that the printer 200 is in a processing state.

The print setting verification operation 606 is for verifying, in the case of the illustrated example, when a print instruction is provided under printing conditions of the number of copies of 100, the sheet size of A4, the sheet type of plain paper, and the sheet feeding source of the main sheet feeding source, whether or not printing can be performed under these conditions. Note that the values (settings) of the conditions are based on the settings of the dropdown 403, the dropdown 405, and the dropdown 407, and so forth, set by operating the set button 413 on the print setting screen 400.

The print setting verification response 607 is a response to the print setting verification operation 606. A value “successful-ok” indicates that the printing under the printing conditions specified in the print setting verification operation 606 can be normally performed. Note that in a case where the printing cannot be performed depending on a combination of settings or in a case where a setting is invalid, the value of “status-code” can be set to another value.

The job generation operation 701 in FIG. 7 is generated in response to the print setting verification operation 606 received in advance, and the verified settings are set therein. The settings of the job generation operation 701 are almost the same as those of the print setting verification operation 606.

The print job response 702 is a response to the job generation operation 701. A “job-id” attribute indicates an ID for uniquely identifying a print job. A “job-state” attribute has, in the illustrated example, a value of “pending” indicating an execution waiting state. A “job-state-reasons” attribute has, in the illustrated example, a value of “none” indicating that no error causing a problem in execution of the print job has occurred.

The print document transmission operation 703 includes print document information. A “document-format” attribute has a value indicating that a print job (document) to be transmitted is a PDF format document. This print job is specified by a value of the “job-id” attribute.

The print document transmission response 704 is a response to the print document transmission operation 703. The print job status is not changed immediately after the print job has been transmitted, and hence here, the values of the “job-state” and “job-state-reasons” attributes are the same as those of the print job response 702.

The print job attribute acquisition request 705 is a request for acquiring the attributes of the print job. Here, the “job-state” attribute and the “job-state-reasons” attribute are requested with respect to the print job of which the “job-id” has a value of “I1”.

The print job attribute acquisition response 706 is a response to the print job attribute acquisition request 705. In the illustrated example, a value “processing” of the “job-state” attribute indicates that an operation is in progress, and a value “job-printing” of the “job-state-reasons” attribute indicates that the print job in question is being executed.

The print job completion response 707 is a response transmitted in a case where the corresponding print job is completed. In the illustrated example, a value “completed” of the “job-state” attribute indicates that the print job is completed, and a value “job-completed-successfully” of the “job-state-reasons” attribute indicates that the corresponding print job is normally completed.

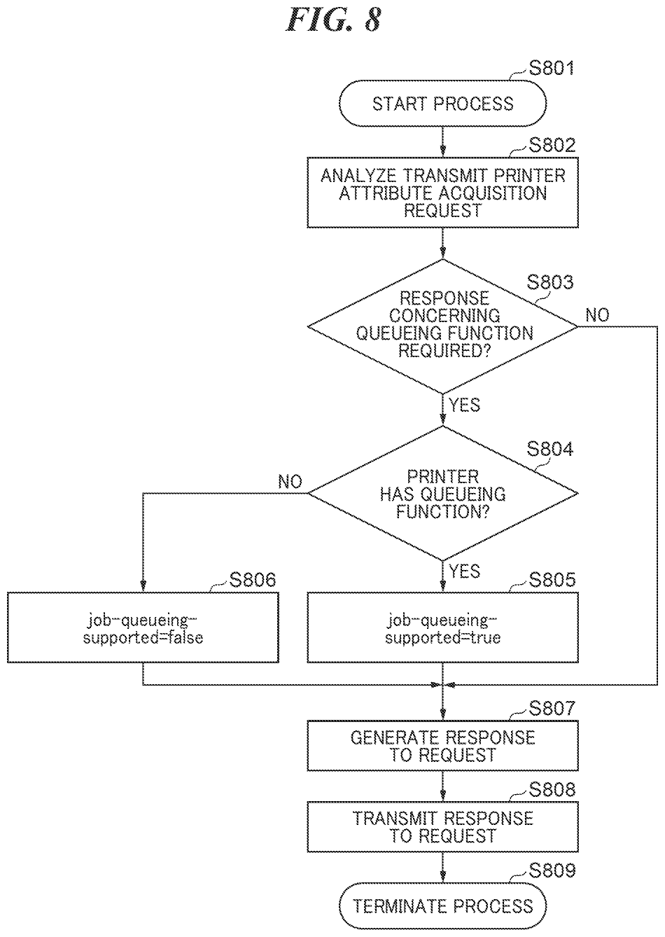

FIG. 8 is a flowchart of a process performed by the printer. The process shown in FIG. 8 corresponds to the process performed by the printer 200 in the sequence diagram shown in FIG. 3. Referring to FIG. 8, in a step S801, the CPU 201 of the printer 200 starts the process in FIG. 8 by executing an associated program, and the process proceeds to a step S802. Note that the process is started in a case where the printer attribute acquisition request 601 is received via the communication section 204.

In the step S802, the CPU 201 analyzes the attributes (“requested-attributes”) requested, for example, by the printer attribute acquisition request 601 or the printer attribute acquisition request 603, and the process proceeds to a step S803.

In the step S803, the CPU 201 determines, based on a result of the analysis in the step S802, whether or not the “job-queueing-supported” attribute or “all” indicating all attributes is included in the “requested-attributes”. That is, the CPU 201 determines whether or not it is necessary to transmit a response indicating whether or not the printer 200 has the queueing function, to the terminal apparatus 100. If it is determined in the step S803 that the “job-queueing-supported” attribute or “all” is included in the “requested-attributes”, the process proceeds to a step S804. On the other hand, if it is determined that neither the “job-queueing-supported” attribute nor “all” is included in the “requested-attributes”, the process proceeds to a step S807.

In the step S804, the CPU 201 determines whether or not the printer 200 has the queueing function, i.e. the printer 200 supports queueing. This determination is performed, for example, based on whether or not the printer 200 has the disk device 210. In a case where the printer 200 has the disk device 210, it is determined that the printer 200 has the queueing function. In a case where the printer 200 does not have the disk device 210, it is determined that the printer 200 does not have the queueing function. Note that the determination in the step S804 can be performed, by displaying, for example, a menu for switching support/non-support of queueing on the display section 206, and then based on an operation of switching support/non-support, performed by the user 300. Then, if it is determined in the step S804 that the printer 200 has the queueing function, the process proceeds to a step S805. On the other hand, if it is determined in the step S804 that the printer 200 does not have the queueing function, the process proceeds to a step S806.

In the step S805, the CPU 201 sets the value of the “job-queueing-supported” attribute in the printer attribute acquisition response 602 or the printer attribute acquisition response 604, which are to be transmitted to the terminal apparatus 100 as a response, to “true”, and then the process proceeds to the step S807. By executing the step S805, the function information indicating that the printer 200 has the queueing function is caused to be included in the printer attribute acquisition response 602 or the printer attribute acquisition response 604.

In the step S806, the CPU 201 sets the value of “job-queueing-supported” attribute in the printer attribute acquisition response 602 or the printer attribute acquisition response 604, which are to be transmitted to the terminal apparatus 100 as a response, to “false”, and then the process proceeds to the step S807. By executing the step S806, the function information indicating that the printer 200 does not have the queueing function is caused to be included in the printer attribute acquisition response 602 or the printer attribute acquisition response 604.

In the step S807, the CPU 201 sets the attribute values other than the “job-queueing-supported” attribute and generates the printer attribute acquisition response 602 or the printer attribute acquisition response 604. Note that detailed description of the attribute values other than the “job-queueing-supported” attribute is omitted.

In a step S808, the CPU 201 transmits the printer attribute acquisition response 602 or the printer attribute acquisition response 604, generated in the step S807, from the communication section 204 to the terminal apparatus 100, and then the process proceeds to a step S809. Thus, in the printer 200, the communication section 204 functions as transmitting means for transmitting the function information to the terminal apparatus 100 in response, for example, to the printer attribute acquisition request 601 or the printer attribute acquisition request 603, received from the terminal apparatus 100.

In the step S809, the CPU 201 terminates the process.

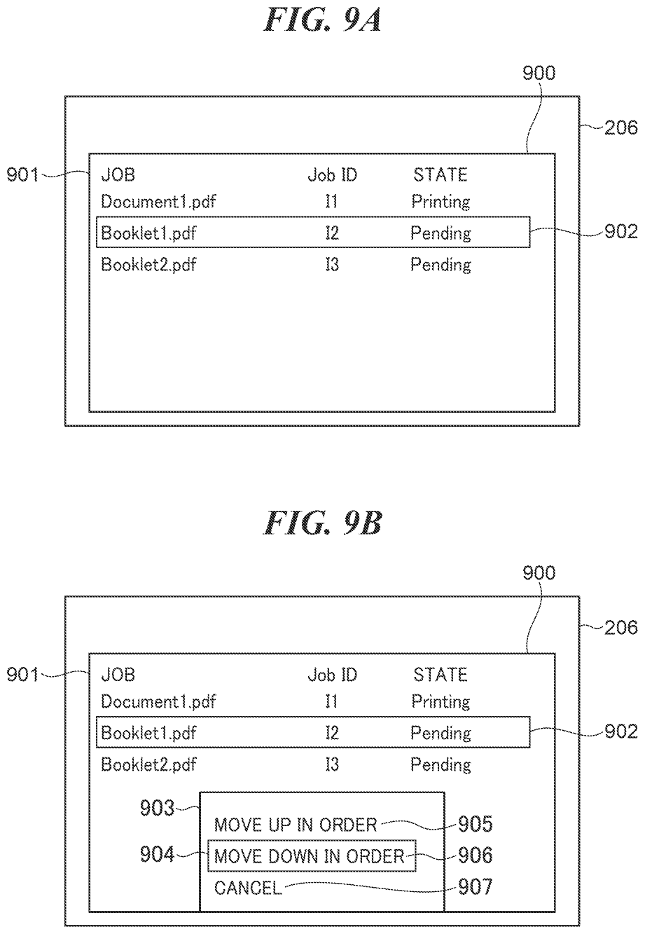

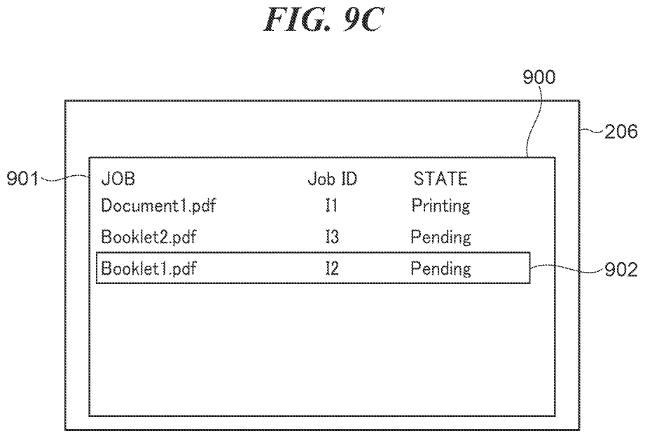

FIGS. 9A to 9C are diagrams each showing an example of a screen displayed on the display section 206 of the printer 200. FIGS. 9A to 9C show a sequence of steps of operation performed on the screen. It is assumed here that the printer 200 described with reference to FIGS. 9A to 9C has the queueing function. As shown in FIG. 9A, a pint job display screen 900 includes a job display area 901 and a selection cursor 902. In the job display area 901, the print job name, the job ID, and the state of the job are displayed. In the illustrated example in FIG. 9A, similarly to the print job management screen 420 (see FIG. 4B), the print jobs named as “Document1.pdf”, “Booklet1.pdf”, and “Booklet2.pdf”, respectively, are displayed. These print jobs are sequentially arranged from the top of the job display area 901. This order is the order in which the print jobs have been received by the printer 200 from the terminal apparatus 100. Then, the print jobs are executed in this order. Further, the job IDs of “Document1.pdf”, “Booklet1.pdf”, and “Booklet2.pdf” are “I1”, “I2”, and “I3”, respectively. The job state of “Document1.pdf” is “executing (printing)”, and the job states of “Booklet1.pdf” and “Booklet2.pdf” are, “waiting (print waiting state)”. The user can select a desired print job and enable the printer 200 to execute processing, described hereafter with reference to FIG. 9B, on the selected print job, by operating the selection cursor 902. In the illustrated example in FIG. 9A, the print job “Booklet1.pdf” is in a state selected by the cursor 902. Then, when the user operates the operation section 205 in this selection state, the print job display screen 900 is shifted to a state shown in FIG. 9B.

On the print job display screen 900 shown in FIG. 9B, an operation window 903 is displayed in the job display area 901. In the operation window 903, there are displayed an option 905 and an option 906 each indicating a change of the order of execution of the print jobs, an option 907 indicating cancellation of the change, and a selection cursor 904 as operating means for executing an operation of changing the order of execution of the print jobs. The option 905 is “move up in order” for moving up in the order of execution. The option 906 is “move down in order” for moving down in the order of execution. The option 907 is “cancel” for canceling the change in the order of execution. The user can select one option of the options 905 to 907 by operating the selection cursor 904. In the illustrated example in FIG. 9B, the option 906 is selected. Then, when the user operates the operation section 205 in this selection state, the print job display screen 900 is shifted to a state shown in FIG. 9C.

On the print job display screen 900 in the state shown in FIG. 9C, the order of execution of “Booklet1.pdf” has been moved down from the second to the third. As a result, in the printer 200, after completion of execution of the print job “Document1.pdf”, the print job “Booklet2.pdf” is executed, and then the print job “Booklet1.pdf” is executed. Thus, in the printer 200, it is possible to execute the print jobs in an order different from the order in which the print jobs were received. With this, the printer 200 can change the processing on the print jobs, which enhances the convenience of the user 300.

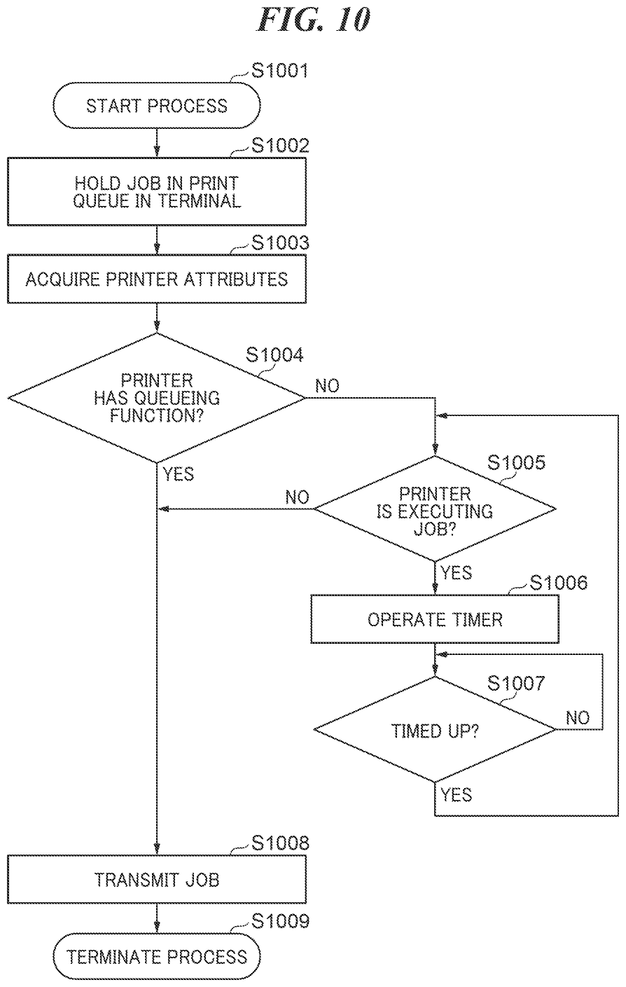

Hereafter, a second embodiment will be described with reference to FIG. 10, but the description is given mainly of different pointes from the above-described embodiment, and description of the same points is omitted. The present embodiment is different from the first embodiment only in the process executed by the terminal apparatus 100 and is the same as the first embodiment in the other points. FIG. 10 is a flowchart of the process performed by the terminal apparatus 100 according to the second embodiment of the present invention. Referring to FIG. 10, in a step S1001, the CPU 101 of the terminal apparatus 100 starts the process in FIG. 10 by executing an associated program, and the process proceeds to a step S1002. Note that the process is started in a case where the set button 413 on the print setting screen 400 displayed on the operation section 105 is selected.

In the step S1002, the CPU 101 holds the print job in the print queue arranged in the RAM 103, and the process proceeds to a step S1003.

In the step S1003, the CPU 101 acquires the printer attribute acquisition response 602, the printer attribute acquisition response 604, and the printer attribute acquisition response 605 from the printer 200 via the communication section 104, and then the process proceeds to a step S1004.

In the step S1004, the CPU 101 determines whether or not the printer 200 has the queueing function based on a result of acquisition in the step S1003. If it is determined in the step S1004 that the printer 200 has the queueing function, the process proceeds to a step S1008. On the other hand, if it is determined in the step S1004 that the printer 200 does not have the queueing function, the process proceeds to a step S1005.

In the step S1005, the CPU 101 determines whether or not the printer 200 is executing a print job based on the result of acquisition in the step S1003. If it is determined in the step S1005 that the printer 200 is executing a print job, the process proceeds to a step S1006. On the other hand, if it is determined in the step S1005 that the printer 200 is not executing a print job, the process proceeds to the step S1008.

In the step S1006, the CPU 101 operates a timer (not shown) incorporated in the terminal apparatus 100, and the process proceeds to a step S1007.

In the step S1007, the CPU 101 determines whether or not the timer has timed up, i.e. whether or not a predetermined time period has elapsed. The predetermined time period is not particularly limited, but for example, the predetermined time period can be set to an average time from the start to the end of execution of a print job in the printer 200. Then, if it is determined in the step S1007 that the timer has timed up, the process returns to the step S1005, and the step S1005 et seq. are sequentially executed. On the other hand, if it is determined in the step S1007 that the timer has not timed up, the process remains in the step S1007.

In the step S1008, the CPU 101 transmits the print job held in the RAM 103 from the communication section 104 to the printer 200, and then the process proceeds to a step S1009. In this step S1008, to the printer 200 having the queueing function, all of the print jobs can be sequentially transmitted regardless of the number of print jobs held in the RAM 103. Further, to the printer 200 which does not have the queueing function, in a case where one print job is held in the RAM 103, the one print job can be transmitted. Further, to the printer 200 which does not have the queueing function, in a case where a plurality of print jobs are held in the RAM 103, one print job of these print jobs can be transmitted.

In the step S1009, the CPU 101 terminates the process.

As described above, the terminal apparatus 100 can transmit a print job to the printer 200 having the queueing function, regardless of whether or not the printer 200 is executing a print job. This is because, since the printer 200 has the queueing function, even when a print job held in the RAM 203 is being executed, the printer 200 is capable of holding the other print jobs. Further, in a case where one print job is transmitted to the printer 200 that does not have the queueing function, if the printer 200 is executing a print job, transmission of the one printer job is temporarily stopped, i.e. canceled. Then, after the lapse of the predetermined time period from the stoppage, if the printer 200 is not executing a print job, the one print job to be transmitted can be transmitted. With this, the printer 200 that does not have the queueing function can receive and hold the one print job.

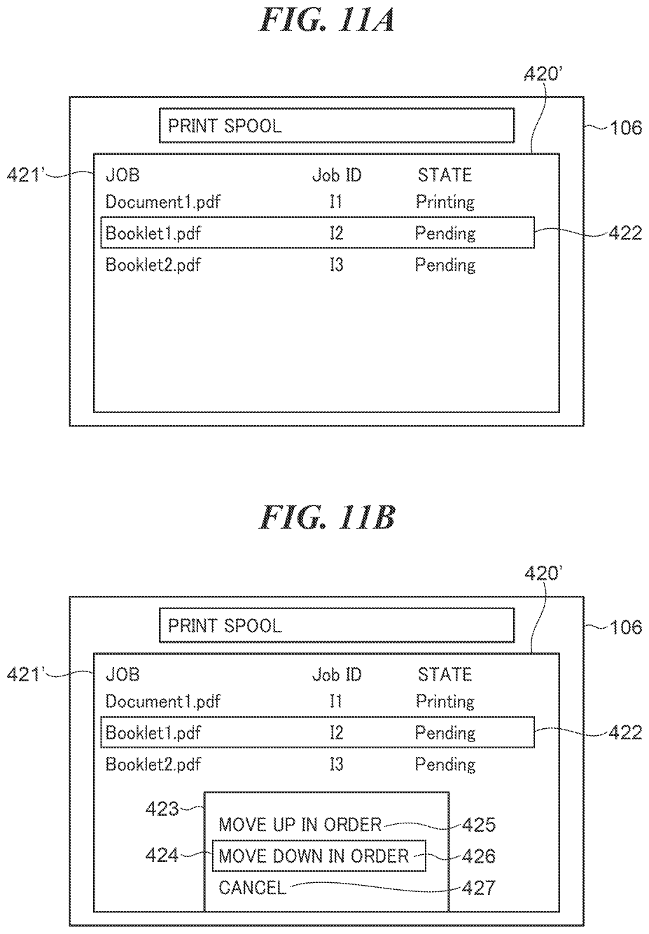

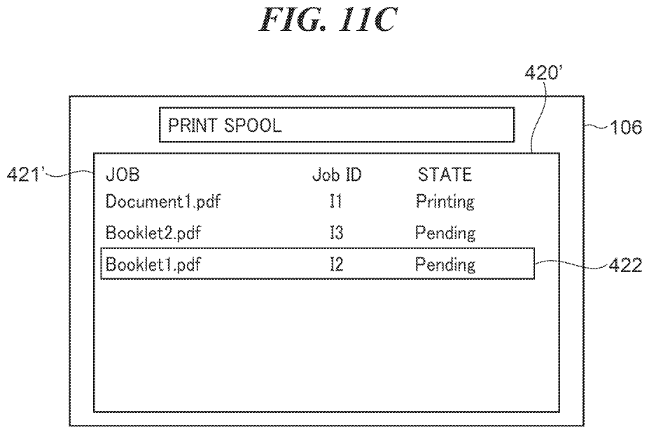

Hereafter, a third embodiment will be described with reference to FIGS. 11A to 11C, but the description is given mainly of different pointes from the above-described embodiments, and description of the same points is omitted. The present embodiment is different from the first embodiment only in the configuration of the print job management screen and is the same as the first embodiment in the other points. That is, while the print job display screen 900 shown in FIGS. 9A to 9C, which is similar to a print job management screen 420′ of the present embodiment, is displayed on the display section 206 of the printer 200, the print job management screen 420′ shown in FIGS. 11A to 11C is displayed on the display section 106 of the terminal apparatus 100 according to the third embodiment of the present invention. While FIGS. 9A to 9C show a sequence of the operation steps performed on the print job display screen 900, FIGS. 11A to 11C show a sequence of the operation steps performed on the print job management screen 420′. Note that it is assumed that the printer 200 in the third embodiment has the queueing function. As shown in FIG. 11A, the print job management screen 420′ further includes a selection cursor 422. The user can select a desired print job from the three print jobs and enable the printer 200 to execute processing with respect to the selected print job by operating the selection cursor 422. In the illustrated example in FIG. 11A, “Booklet1.pdf” is in a state selected by the cursor 422. Then, when the user operates the operation section 105 in this selection state, the print job management screen 420′ is shifted to a state shown in FIG. 11B.

On the print job management screen 420′ shown in FIG. 11B, an operation window 423 is further displayed in a job management area 421′. In the operation window 423, there are displayed an option 425 and an option 426 each indicating a change of the order of transmission of the print jobs, an option 427 indicating cancellation of the change, and a selection cursor 424 as operating means for executing an operation of changing the order of transmission of the print jobs. The option 425 is “move up in order” for moving up in the order of transmission. The option 426 is “move down in order” for moving down in the order of transmission. The option 427 is “cancel” for canceling the change in the order of transmission. The user can select one of the options 425 to 427 by operating the selection cursor 424. In the illustrated example in FIG. 11B, the option 426 is selected. Then, when the user operates the operation section 105 in this selection state, the print job management screen 420′ is shifted to a state shown in FIG. 11C.

On the print job management screen 420′ in the state shown in FIG. 11C, the order of transmission of “Booklet1.pdf” is moved down from the second to the third. As a result, in the terminal apparatus 100, the print jobs are transmitted in the order of “Document1.pdf”, “Booklet2.pdf”, and “Booklet1.pdf”. Thus, in the terminal apparatus 100, it is possible to transmit the print jobs to the printer 200 in an order different from the original order in which the print jobs have been generated. With this, the terminal apparatus 100 can change the order of transmission of the print jobs before transmitting the print jobs, which enhances the convenience of the user 300. For example, let it be assumed that the terminal apparatus 100 and the printer 200 are disposed in different rooms, respectively. In this case, the user 300 who has operated the terminal apparatus 100 is required to go to the printer 200 disposed in the other room (such as a printing room) to take a printout. Further, let it be assumed that the original order of printing is an order of “Document1.pdf”, “Booklet1.pdf”, and “Booklet2.pdf”. At this time, the user 300 can consider that it is preferable to set the order of “Document1.pdf”, “Booklet2.pdf”, and “Booklet1.pdf” as the order of printing of the printouts rather than the original order, from the view point of binding the printouts after taking out the printouts. In this case, it is more convenient for the user 300 to change the order of printing on the spot, i.e. on the terminal apparatus 100 than to take the trouble of changing the order of printing using the printer 200 disposed in the other room. Then, in the printer 200, the print jobs are executed in the order of “Document1.pdf”, “Booklet2.pdf”, and “Booklet1.pdf”. Note that in the printer 200, it is possible to further change the order of execution of the print jobs from the print job display screen 900.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-001228 filed Jan. 6, 2023, which is hereby incorporated by reference herein in its entirety.

What is claimed is:

1. A method of controlling an information processing apparatus having a general-purpose driver that operates according to IPP, comprising:
acquiring information on whether or not a job management apparatus has a queueing function of queueing a plurality of jobs; and
changing a method of transmitting jobs generated by the general-purpose driver, based on the acquired information.

2. The method according to claim 1, further comprising determining whether or not the job management apparatus has the queueing function, based on the information, and
wherein a new job is transmitted in a case where it is determined that the job management apparatus has the queueing function, and that the job management apparatus is executing a job, whereas transmission of a new job is inhibited in a case where it is determined that the job management apparatus does not have the queueing function, and that the job management apparatus is executing a job.

3. The method according to claim 2, wherein in a case where it is determined that the job management apparatus does not have the queueing function, and that the job management apparatus is executing a job, the new job is transmitted after execution of the job is completed.

4. The method according to claim 2, wherein in a case where it is determined that the job management apparatus does not have the queueing function, and that the job management apparatus is not executing a job, the new job is transmitted.

5. The method according to claim 2, wherein determination of whether or not the job management apparatus has the queueing function is performed in a case where execution of the job is instructed.

6. The method according to claim 1, further comprising notifying a user of whether or not the job management apparatus has the queueing function, based on the information.

7. The method according to claim 1, further comprising receiving an operation of changing the order of transmission of jobs, from a user.

8. The method according to claim 1, wherein the job management apparatus is a printer, and
wherein the job is a print job.

9. A computer-readable storage medium storing a program for controlling an information processing apparatus having a general-purpose driver that operates according to IPP, the program comprising:
a code for acquiring information on whether or not a job management apparatus has a queueing function of queueing a plurality of jobs; and
a code for changing a method of transmitting jobs generated by the general-purpose driver, based on the acquired information.
